(19) United States
(12) Patent Application Publication
(10) Pub. No.: US 2026/0095367 A1
(43) Pub. Date: Apr. 2, 2026

(54) Network Self-Healing and Fault Optimization

(71) Applicant: Dell Products L.P., Round Rock, TX (US)

(72) Inventor: Eman Khaled, Street Elkha (EG)

(21) Appl. No.: 18/900,063

(22) Filed: Sep. 27, 2024

(51) Int. Cl. H04L 41/0659; H04L 43/16

(52) U.S. Cl. CPC H04L 41/0661; H04L 43/16

(57) ABSTRACT

A system can identify that at least one key performance indicator is not satisfied for broadband cellular communications facilitated by a group of cells. The system can reroute a user equipment among the group of cells based on the identifying. The system can obtain a fault-detection model based on a linear programming process applied to the identifying. The system can initiate a restart operation of a cell of the group of cells based on an output of the fault-detection model.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify that at least one key performance indicator is not satisfied for broadband cellular communications facilitated by a group of cells. The system can reroute a user equipment among the group of cells based on the identifying. The system can obtain a fault-detection model based on a linear programming process applied to the identifying. The system can initiate a restart operation of a cell of the group of cells based on an output of the fault-detection model.

An example method can comprise, based on determining that at least one key performance indicator indicates that a group of cells is unable to facilitate broadband cellular communications, rerouting, by a system comprising at least one processor, a user equipment among the group of cells, and generating, by the system, a fault-detection model based on a result of applying linear programming to the determining. The method can further comprise initiating, by the system, a restart operation of a cell of the group of cells based on an output from the fault-detection model.

An example non-transitory computer-readable medium can comprise instructions that, in response to execution, cause a system comprising a processor to perform operations. These operations can comprise, based on determining that a key performance indicator is not threshold sufficient for broadband cellular communications facilitated by cells, rerouting a user equipment among the cells. These operations can further comprise restarting a cell of the cells based on an output of a fault-detection model that was generated based on a linear programming process applied to the determining.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate network self-healing and fault optimization, in accordance with an embodiment of this disclosure;

FIG. 2 illustrates another example system architecture that can facilitate network self-healing and fault optimization, in accordance with an embodiment of this disclosure;

FIG. 3 illustrates an example signal flow that can facilitate network self-healing and fault optimization, in accordance with an embodiment of this disclosure;

FIG. 4 illustrates an example table of parameters that can facilitate network self-healing and fault optimization, in accordance with an embodiment of this disclosure;

FIG. 5 illustrates an example process flow for fault detection, and that can facilitate network self-healing and fault optimization, in accordance with an embodiment of this disclosure;

FIG. 6 illustrates an example process flow for fault optimization, and that can facilitate network self-healing and fault optimization, in accordance with an embodiment of this disclosure;

FIG. 7 illustrates an example table of results of traffic re-routing decisions, and that can facilitate network self-healing and fault optimization, in accordance with an embodiment of this disclosure;

FIG. 8 illustrates another example system architecture that can facilitate network self-healing and fault optimization, in accordance with an embodiment of this disclosure;

FIG. 9 illustrates another example process flow that can facilitate network self-healing and fault optimization, in accordance with an embodiment of this disclosure;

FIG. 10 illustrates another example process flow that can facilitate network self-healing and fault optimization, in accordance with an embodiment of this disclosure;

FIG. 11 illustrates another example process flow that can facilitate network self-healing and fault optimization, in accordance with an embodiment of this disclosure; and

FIG. 12 illustrates an example block diagram of a computer operable to execute an embodiment of this disclosure.

### DETAILED DESCRIPTION

### Overview

Numerous problems can occur in computer networks, particularly for telecommunications (“telco”) operators that can have tight key performance indicators (KPIs) that need to be met. Therefore it can be important to have intelligent network resiliency and fault recovery techniques within the network.

The present techniques can address problems with telecommunications network operation by facilitating monitoring both user equipment (UE) and cell-level KPIs in a scalable and efficient manner to detect and isolate and/or fix failures (where possible). In some examples, machine learning (ML) techniques can be implemented to mitigate against future faults, such as ones that can cause a failure to comply with service level agreements (e.g., 99.999%—“five 9s”—availability), considering a complexity of open radio access network (O-RAN) broadband cellular network deployments, and multiple factors that can affect network performance.

In some examples, the present techniques can be implemented with traffic routing and fault detection xApps, and fault mitigation and restart rApps—along with corresponding orchestration between these entities—to achieve network fault detection, isolation, mitigation, and traffic rerouting.

In some examples, present techniques can be implemented using components of an O-RAN architecture such as a near-real time RAN intelligent controller (nRT-RIC), a non-real time RIC (nonRT-RIC), and distributed units (DUs) and centralized units (CUs) as RAN nodes.

RAN disaggregation and multiple function split within a RAN can lead to increasing complexity and more reliance on KPIs to measure and monitor the performance of the network. Communication service providers (CSPs) can face significant challenges in effectively managing and achieving their KPIs. These challenges can include:
A lack of centralized data between different vendors;
A manual and time-consuming processes;
An inability to align KPIs with strategic objectives; and
Inadequate visibility and transparency.

### Example Architectures, Tables, and Flows

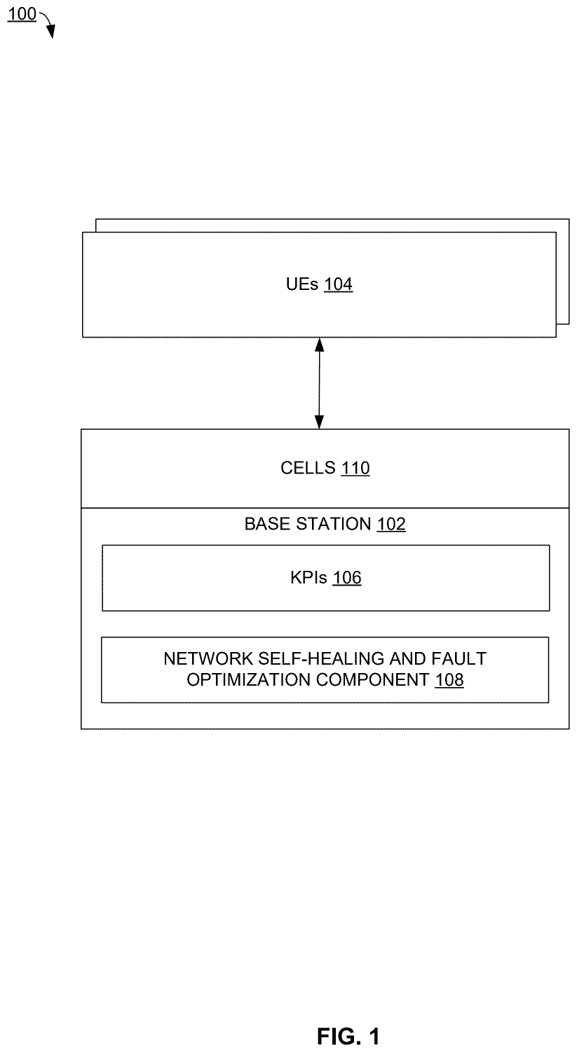

FIG. 1 illustrates an example system architecture 100 that can facilitate network self-healing and fault optimization, in accordance with an embodiment of this disclosure.

System architecture 100 comprises base station 102, UEs 104, and cells 110. In turn, base station 102 comprises key performance indicators (KPIs) 106, network self-healing and fault optimization component 108.

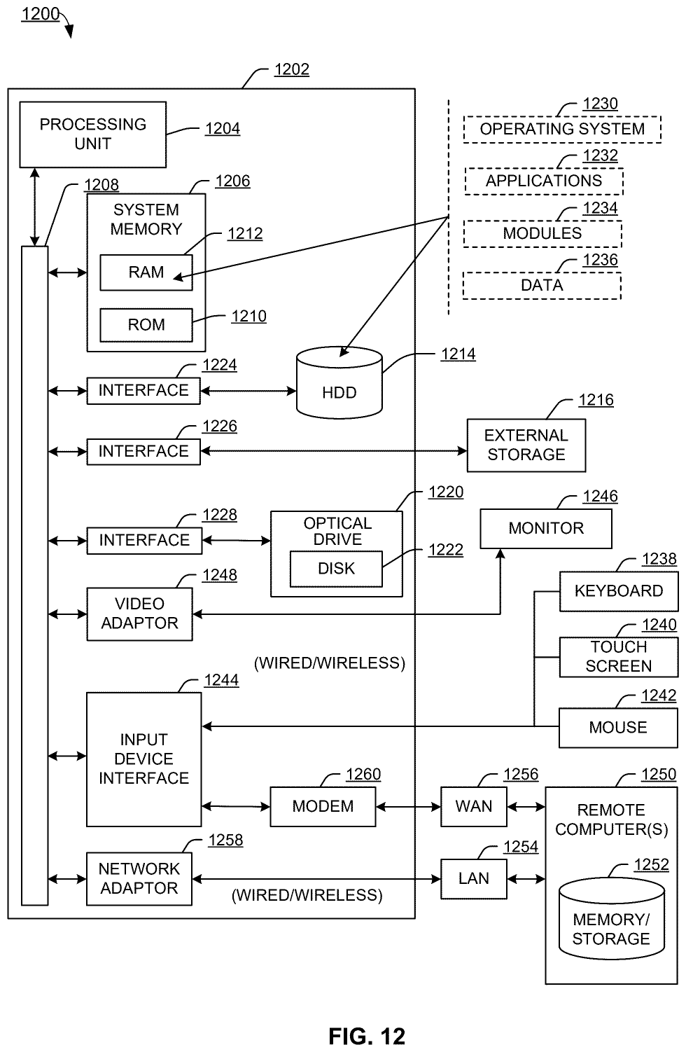

Each of base station 102, UEs 104, and or cells 110 can be implemented with part(s) of computing environment 1200 of FIG. 12.

Network self-healing and fault optimization component 108 can analyze information about KPIs of UEs 104 and cells 110, where respective UEs of UEs 104 can be connected to respective cells of cells 110. Based on this analysis, network self-healing and fault optimization component 108 can perform a healing function, such as rerouting network traffic or restarting a cell

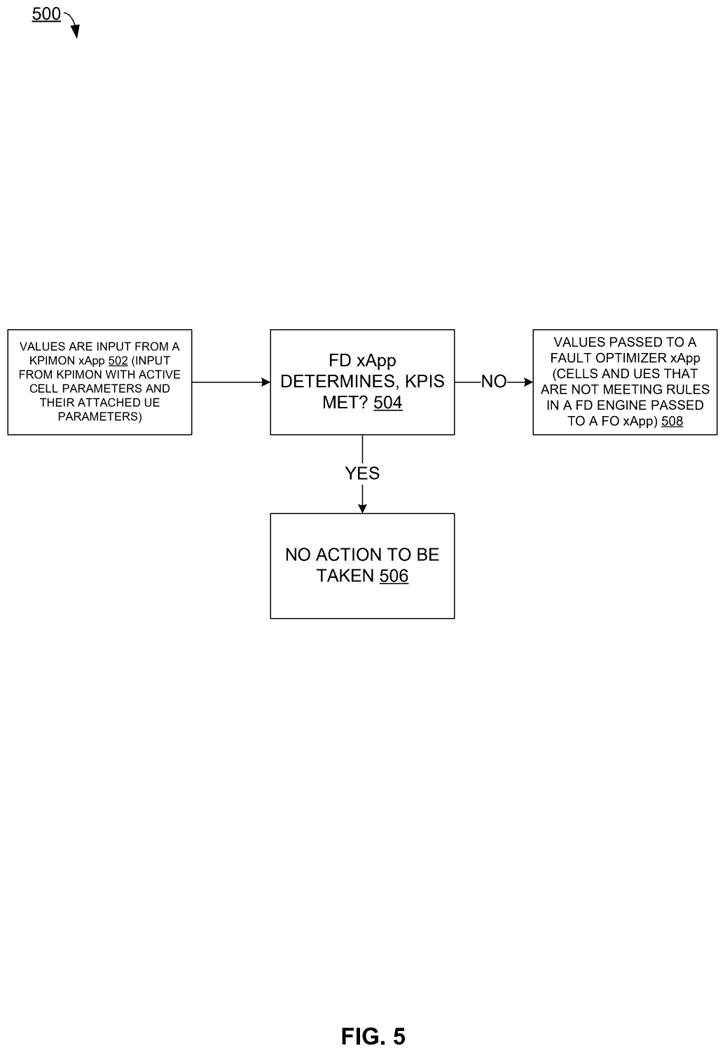

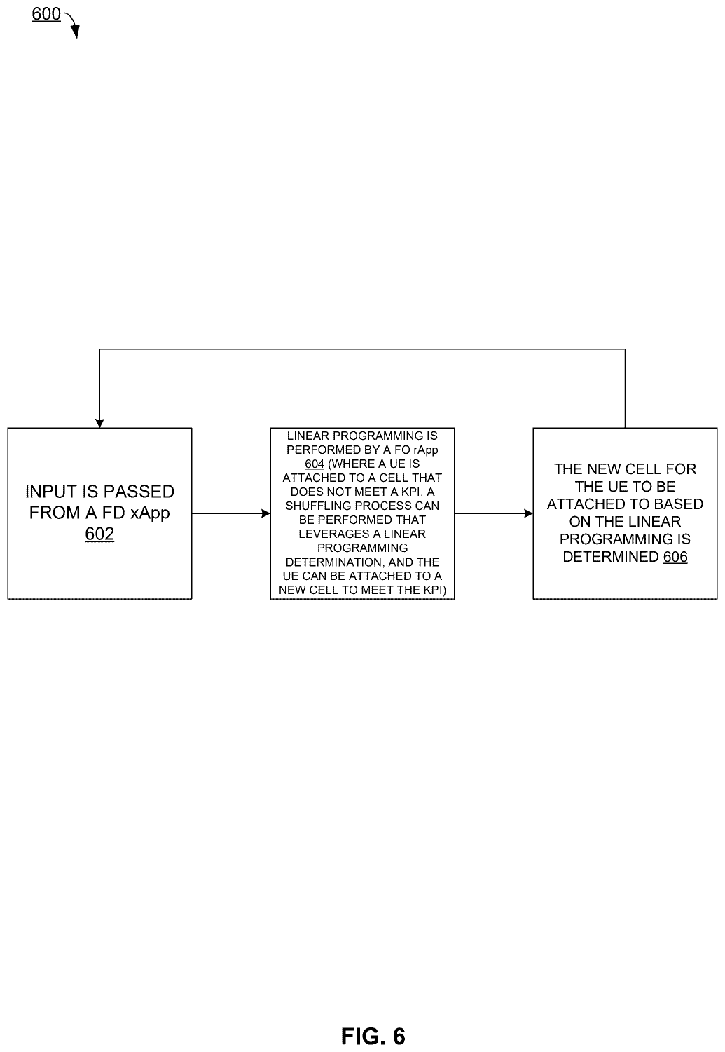

In some examples, network self-healing and fault optimization component 108 can implement part(s) of the process flows of FIGS. 5-6 and/or 9-11 to facilitate network self-healing and fault optimization.

It can be appreciated that system architecture 100 is one example system architecture for network self-healing and fault optimization, and that there can be other system architectures that facilitate network self-healing and fault optimization.

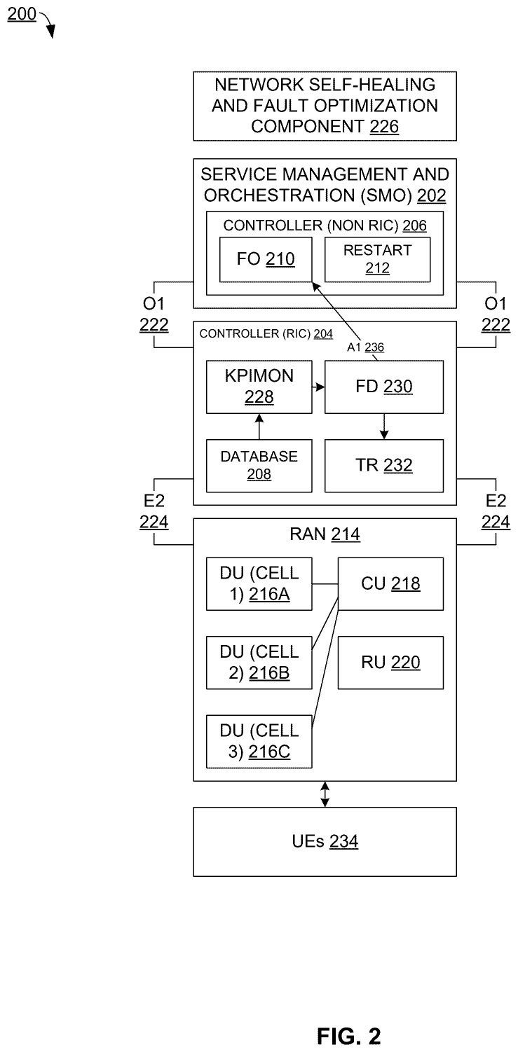

FIG. 2 illustrates another example system architecture 200 that can facilitate network self-healing and fault optimization, in accordance with an embodiment of this disclosure. In some examples, part(s) of system architecture 200 can be implemented by part(s) of system architecture 100 of FIG. 1 to facilitate network self-healing and fault optimization.

System architecture 200 comprises service management and orchestration (SMO) 202, controller (RIC) 204, controller (non-RIC) 206, database 208, FL 210, restart 212, RAN 214, DU (cell 1) 216A, DU (cell 2) 216B, DU (cell 3) 216C, CU 218, RU 220, O1 222, E2 224, network self-healing and fault optimization component 226 (which can be similar to network self-healing and fault optimization component 108 of FIG. 1), KPIMON 228, FD 230, TR 232, UEs 234, and AI 236.

In such an architecture, components can be configured to do the following.
SMO 202: acts as a management and orchestration layer that controls configuration and automation aspects of RIC and RAN elements.
rApps:
   FL 210: A fault learner rApp that communicated with the fault detection (FD 230) xApp that can comprise an embedded AI/ML model to learn about the pattern of network failures and proactively do traffic rerouting before the failure is triggered.
   Restart 212: This can restart the cell that a UE is connected to if the threshold of failures was exceeded within a certain amount of time
Controller:
   Database 208: This can store KPIs, and store interference pattern information and output action from a handler.
xApps:
   KPIMON 228: This can connect to database 208 to fetch information about the network KPIs.
   TR 232: This can reroute the network traffic if failure was triggered or KPIs were not met.
   FD 230: This can analyze the data from KPIMON 228 to detect the failure and take the next action accordingly.
RAN 214:
   DU 216A, 216B, 216C: This can be a distributed unit that supports multiple layers of RUs to handle digital signal processing and accelerate network traffic sits between a RU and DU to perform real-time L2 functions and baseband processing.
   CU 218: This can be a centralized unit that provides centralized processing and control functions for a component of a RAN.
   RU 220: This can communicate at certain air wave frequencies to interface with an antenna at one side and with a baseband unit at another side to decide a coverage of power capability.
UEs 234: These can comprise devices such as smart phones or laptops that are used directly by an end user for communication.

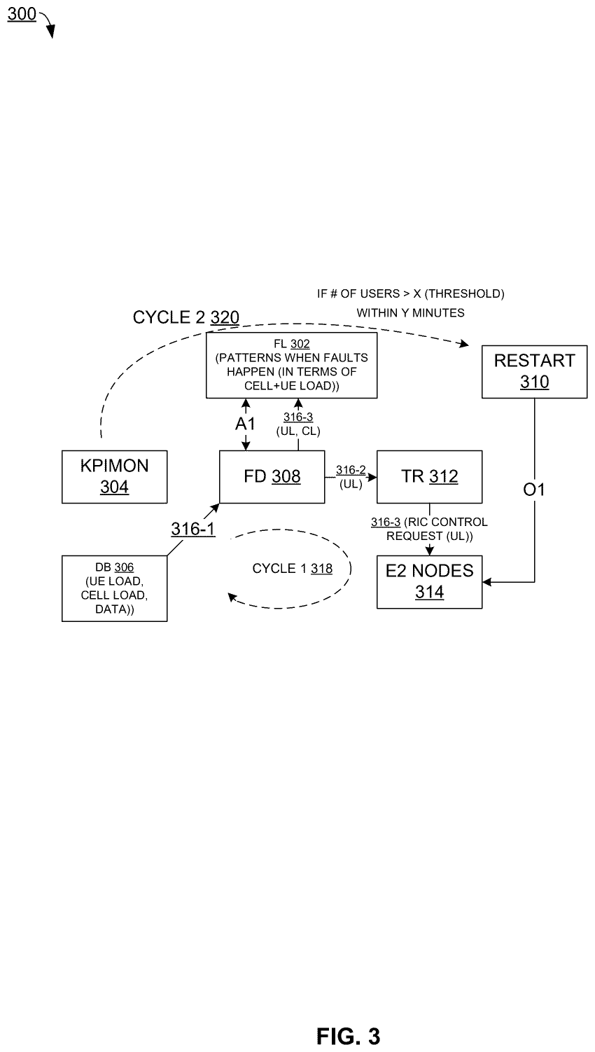

FIG. 3 illustrates an example signal flow 300 that can facilitate network self-healing and fault optimization, in accordance with an embodiment of this disclosure. In some examples, part(s) of signal flow 300 can be implemented by part(s) of system architecture 100 of FIG. 1 to facilitate network self-healing and fault optimization.

Signal flow 300 comprises FL 302, KPIMON 304, DB 306, FD 308, restart 310, TR 312, and E2 nodes 314, where signals can be transmitted between these components.

These signals can comprise cycle 1 318 (comprising 316-1, 316-2, and 316-3), and cycle 2 320.

The present techniques can be implemented via a fault learner rApp (which can be referred to as a fault optimizer rApp) and a restart rApp (to restart a cell). There can also be xApps that utilize a KPI monitoring xApp, such as a traffic re-routing xApp and a restart xApp.

In some examples, the present techniques can be implemented via a two-cycle process. In a first cycle, the KPI monitoring xApp can fetch a database of recent logs, and communicate with a fault detection xApp to detect and analyze errors based on KPIs that indicate a failure to meet a performance criterion. The fault detection xApp can communicate with the traffic re-routing xApp with UE logs to perform traffic rerouting based on the fault detection xApp input.

In a second cycle, the fault detection xApp can communicate with the fault optimizer rApp to provide UE and cell log feedback on a cadence of detecting faults in a RAN. The fault optimizer rApp can comprise linear programming to facilitate optimizing (or sufficiently facilitating) fault occurrences for failing to meet targeted SLAs for user devices, and re-attaching a UE to a new cell for better performance through an AI interface.

The fault optimization rApp can communicate with the restart rApp to initiate a cell restart operation based on input received from the fault optimization rApp. In some examples, a cell restart operation can be initiated where a number of users within a cell exceeds a threshold value within X minutes. This threshold value can be defined by a mobile network operator (MNO) to meet an SLA for users.

In examples of the present techniques, KPI monitoring xApp can fetch the following fields:
RRC_Max_Connected_Users: Radio Resource Control (RRC) maximum number of users connected per cell as defined by the MNO;
RRC_AVG_Connected_Users: RRC average number of users connected per cell as defined by the MNO;
DL_PRB_Utilization (%): Download physical resource block (PRB) utilization as defined by the MNO;
UL_PRB_Utilization (%): Upload PRB utilization as defined by the MNO;
Average BLER %: Average tolerated block error rate (BLER) as defined by the MNO;
Average_DL_USER_Thpt: Average download throughput per user as defined by the MNO; and
Average_UL_USER_Thpt: Average upload throughput per user as defined by the MNO.

In examples, a variable X can be used, which indicates a matrix of dimensions n*m, where each row represents a cell, and each column represents a UE device as a vector parameter (with the variables mentioned above) that is attached to each cell.

For example, X(1,1) represents the parameters that are fetched by the KPI monitoring xApp for User Equipment 1 (UE1) that is attached to Cell 1.

That is, in this matrix, each cell can represent a value for a field and a corresponding UE that that value applies to (and where the UE is attached to the base station in question).

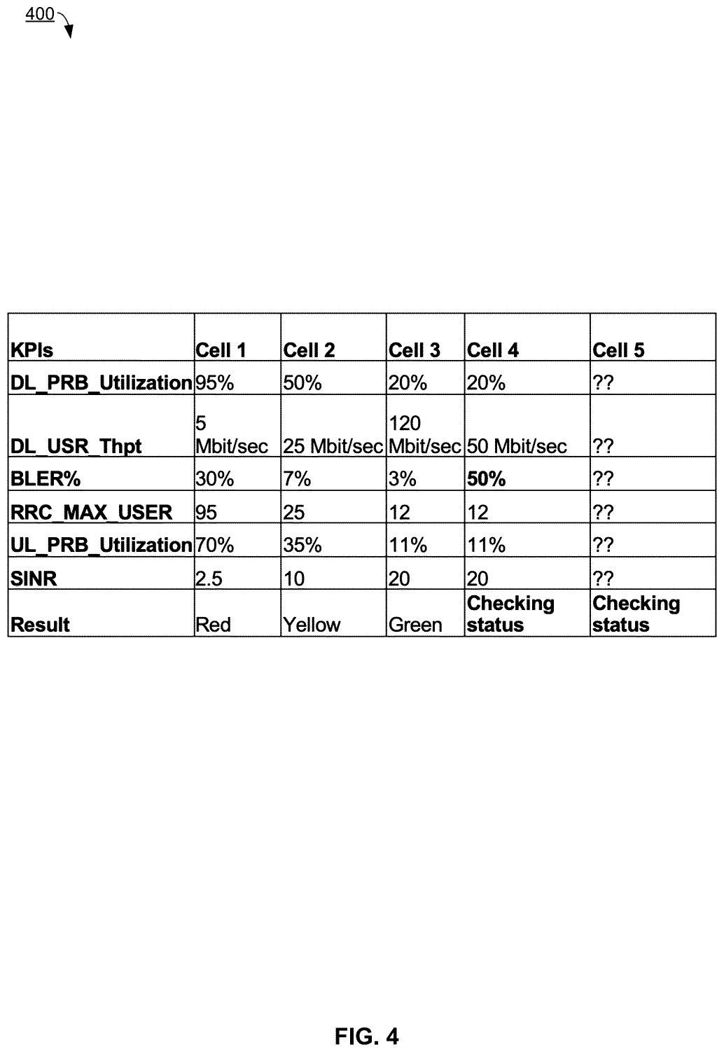

FIG. 4 illustrates an example table 400 of parameters that can facilitate network self-healing and fault optimization, in accordance with an embodiment of this disclosure. In some examples, part(s) of table 400 can be implemented by part(s) of system architecture 100 of FIG. 1 to facilitate network self-healing and fault optimization.

A KPI monitoring xApp can fetch KPI parameters that can be communicated to a fault detection xApp. Table 400 identifies example parameters that the KPI monitoring xApp can fetch.

In this example, a fault detection xApp can consider a cell with these KPI values to be a red flagged cell, which can mean that the preference is that it does not accept new users.

In some examples, criteria can be varied and modified, and all cells can be categorized.

FIG. 5 illustrates an example process flow 500 for fault detection, and that can facilitate network self-healing and fault optimization, in accordance with an embodiment of this disclosure. In some examples, one or more embodiments of process flow 500 can be implemented by system architecture 100 of FIG. 1, or computing environment 1200 of FIG. 12.

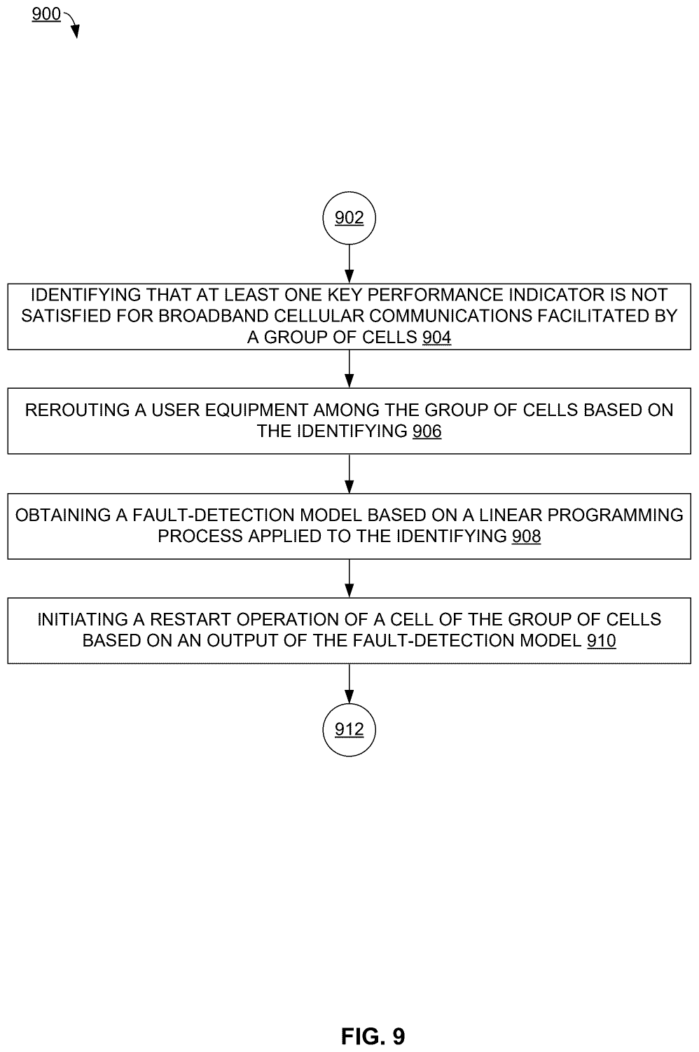

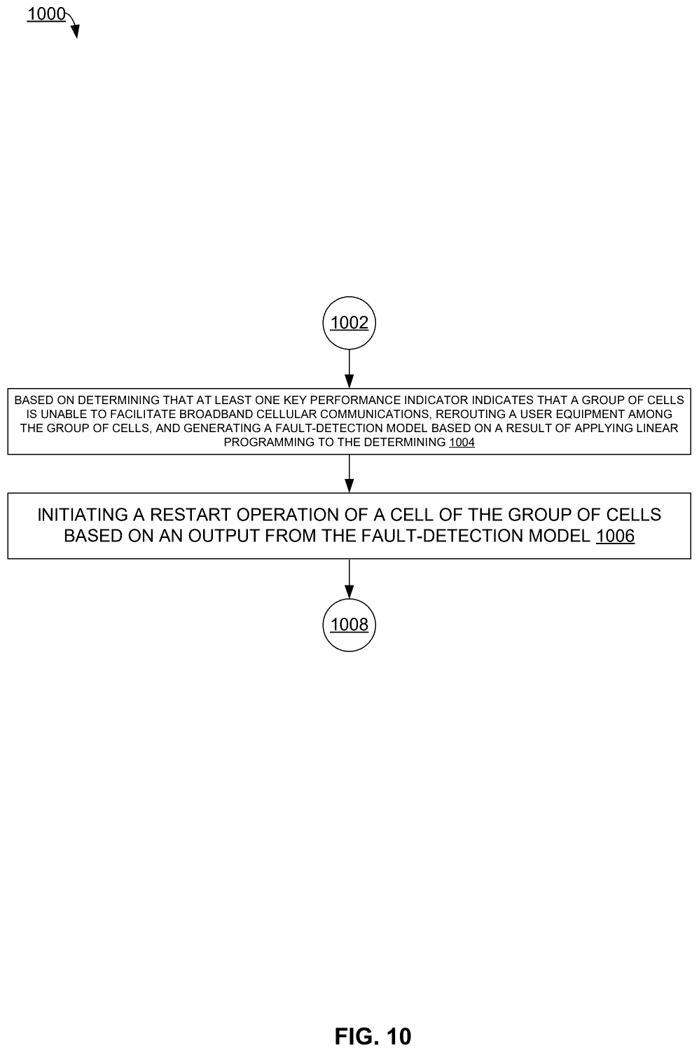

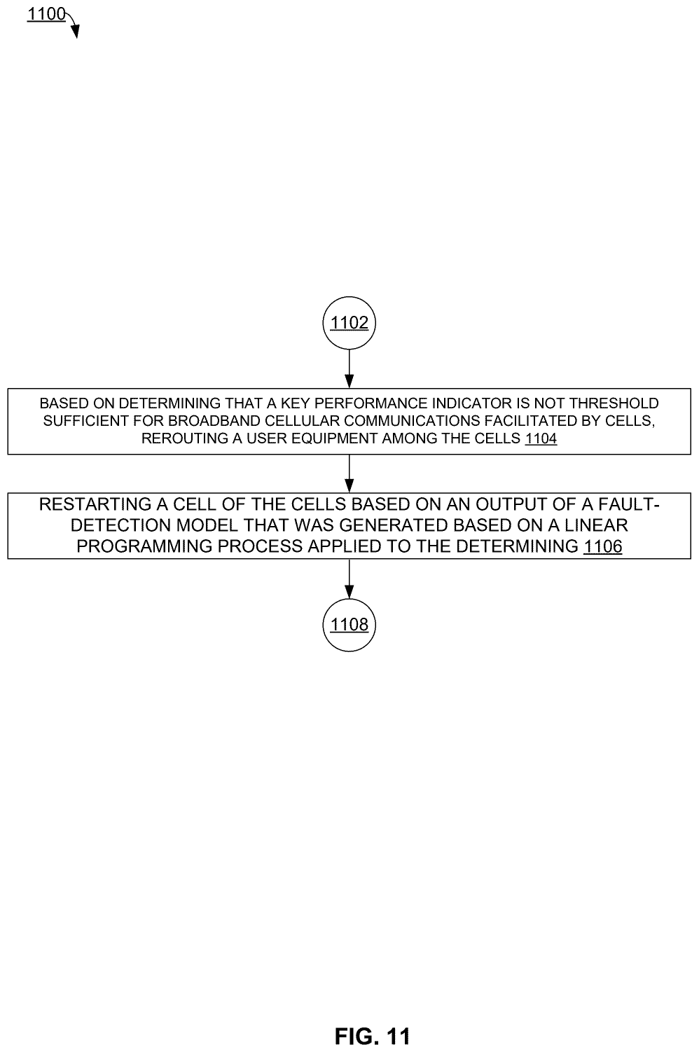

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 600 of FIG. 6, process flow 900 of FIG. 9, process flow 1000 of FIG. 10, and/or process flow 1100 of FIG. 11.

A fault detection xApp can assess the parameters from the KPI monitoring xApp to detect if the monitored values meet the defined KPIs or not. The fault detection xApp can determine, based on these KPIs, whether the current user or cell performance is deteriorating, and can share this information with the traffic re-routing xApp.

In some examples, the fault detection xApp can determine deterioration where the following KPI values are true:

“RRC_Max_Connected_Users > 70” AND “BLER> 25%” AND
“Average_DL_USER_Thpt <10 Mbps” AND “PRB Utilization > 80%”

At 502, values are input from a KPIMON xApp. This can comprise input from KPIMON with active cell parameters and their attached UE parameters.

At 504, it is determined whether the KPIs were met. This determining can be performed by a FD xApp. Where it is determined that the KPIs were met, at 504 it can be determined that no action is to be taken 506.

Instead, where it is determined that the KPIs were not met, at 508, values can be passed to a fault optimizer xApp. That is, cells and UEs that are not meeting rules in a FD engine can be passed to a FO xApp.

FIG. 6 illustrates an example process flow 600 for fault optimization, and that can facilitate network self-healing and fault optimization, in accordance with an embodiment of this disclosure. In some examples, one or more embodiments of process flow 600 can be implemented by system architecture 100 of FIG. 1, or computing environment 1200 of FIG. 12.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 500 of FIG. 5, process flow 900 of FIG. 9, process flow 1000 of FIG. 10, and/or process flow 1100 of FIG. 11.

A fault optimization rApp can utilize linear programming with a Matrix input X (as described previously) that can perform a set of iterations to use in combinatorial optimizations on the input versus the targeted KPIs to reattach the UE with the best available (or suitable) cell to meet the SLAs.

The fault optimization rApp can continue modifying the approach to improve its overall performance and changing the criteria of cells between red flags, green status, and yellow based on the over spectrum efficiency and average_user_thpt per cell, which can reflect a main category of user performance.

The fault optimization rApp can improve its detection calculation with time.

At 602, input is passed from a FD xApp.

At 604, linear programming is performed by a FO rApp. Where a UE is attached to a cell that does not meet a KPI, a shuffling process can be performed that leverages a linear programming determination, and the UE can be attached to a new cell to meet the KPI.

At 606, a new cell is determined for the UE to attach to, based on the linear programming.

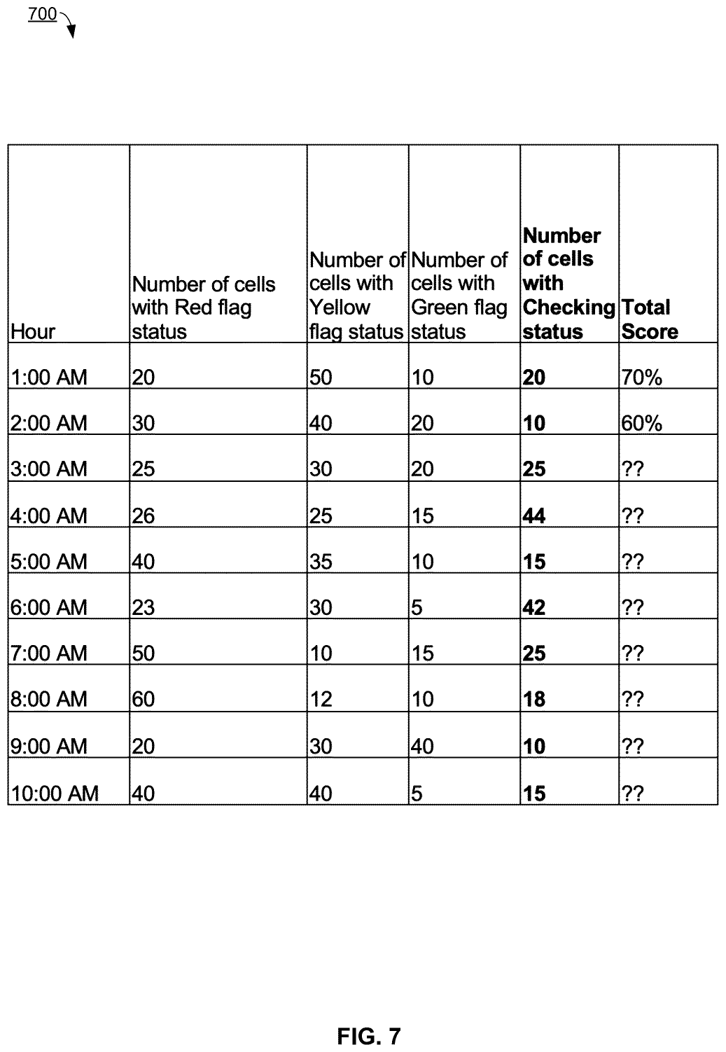

FIG. 7 illustrates an example table 700 of results of traffic re-routing decisions, and that can facilitate network self-healing and fault optimization, in accordance with an embodiment of this disclosure. In some examples, part(s) of table 700 can be implemented by part(s) of system architecture 100 of FIG. 1 to facilitate network self-healing and fault optimization.

A traffic re-routing xApp can take a role of decision maker to deal with users who are coming to the cell, or users who have a bad experience.

The traffic re-routing xApp can monitor the individual user performance after routing it to a different cell, and also monitor the overall performance of the network and the continuous changes of the situation from the fault detection for the number of cells with green status, red flag, or checking status.

Table 700 represents an example of the results of traffic re-routing decisions and how they can be benchmarked.

The traffic re-routing xApp routing can monitor the result of its overall decisions, such as hour by hour, which, with deep learning algorithms can enhance the overall performance of the network.

A total score of the network can represent the performance of the overall network based on the status of each cell that is defined in the fault detection xApp can be a result of benchmarking the performance of the traffic re-routing xApp and its decisions.

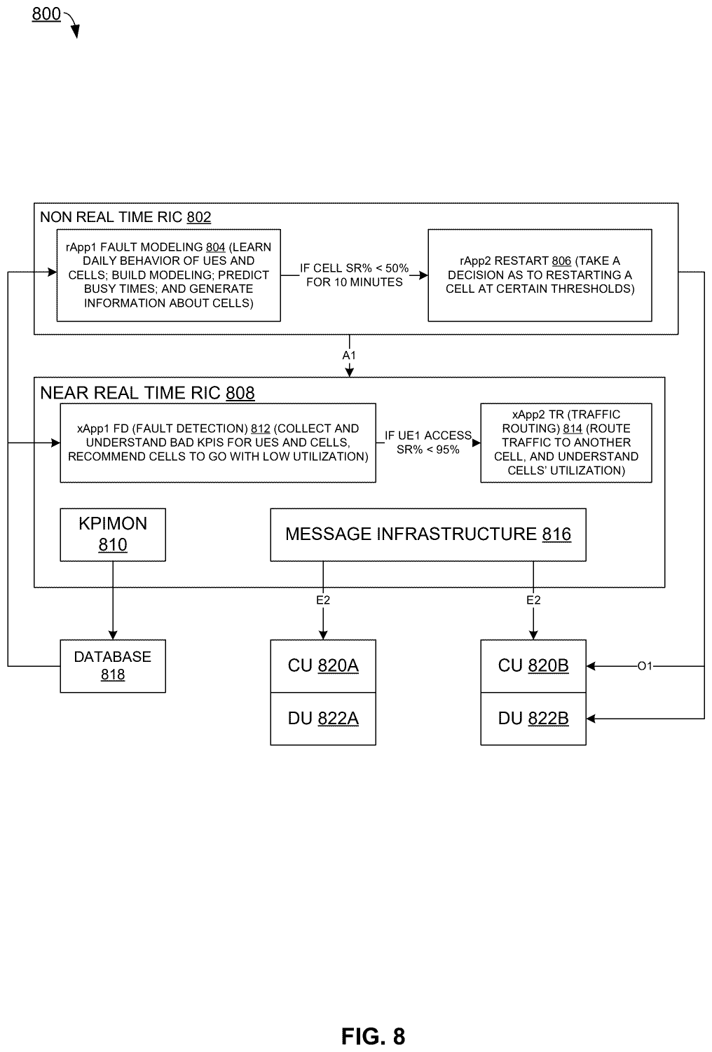

FIG. 8 illustrates another example system architecture 800 that can facilitate network self-healing and fault optimization, in accordance with an embodiment of this disclosure. In some examples, part(s) of system architecture 800 can be implemented by part(s) of system architecture 100 of FIG. 1 to facilitate network self-healing and fault optimization.

System architecture 800 can be implemented to facilitate correlated modeling for cell behavior improvement through traffic routing.

System architecture 800 comprises non real time RIC 802, rApp1 fault modeling 804, rApp2 restart 806, near real time RIC 808, KPIMON 810, xApp1 FD (fault detection) 812, xApp2 TR (traffic routing) 814, message infrastructure 816, database 818, CU 820A, CU 820B, DU 822A, and DU 822B.

rApp1 fault modeling 804 can learn daily behavior of UEs and cells; build modeling; predict busy times; and generate information about cells.

rApp2 restart 806 can take a decision as to restarting a cell at certain thresholds.

xApp1 FD (fault detection) 812 can collect and understand bad KPIs for UEs and cells, and recommend cells to go with low utilization.

xApp2 TR (traffic routing) 814 can route traffic to another cell, and understand cells' utilization.

### Example Process Flows

FIG. 9 illustrates an example process flow 900 for fault optimization, and that can facilitate network self-healing and fault optimization, in accordance with an embodiment of this disclosure. In some examples, one or more embodiments of process flow 900 can be implemented by system architecture 100 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 500 of FIG. 5, process flow 600 of FIG. 6, process flow 1000 of FIG. 10, and/or process flow 1100 of FIG. 11.

Process flow 900 begins with 902, and moves to operation 904.

Operation 904 depicts identifying that at least one key performance indicator is not satisfied for broadband cellular communications facilitated by a group of cells. That is, an FD xApp can determine that KPIs are not being met based on recent logs from a KPIMON xApp.

After operation 904, process flow 900 moves to operation 906.

Operation 906 depicts rerouting a user equipment among the group of cells based on the identifying. That is, the FD xApp can communicate with a TR xApp to perform traffic re-routing.

After operation 906, process flow 900 moves to operation 908.

Operation 908 depicts obtaining a fault-detection model based on a linear programming process applied to the identifying. That is, a FO xApp can receive information from the FD xApp and generate a model of the system based on linear programming.

In some examples, the obtaining of the fault-detection model is based on applying the linear programming process to a matrix, wherein respective rows of the matrix represent respective cells of the group of cells, and wherein respective columns of the matrix represent respective vector parameters of respective user equipment that have communicated with the respective cells. In some examples, respective elements of the matrix identify the respective user equipment that are attached to the respective cells. That is, in some examples, a variable X can be used, which indicates a matrix of dimensions n*m, where each row represents a cell, and each column represents a UE device as a vector parameter (with the variables mentioned above) that is attached to each cell.

In some examples, the linear programming process comprises performing iterations of forming combinatorial optimizations. That is, a fault optimization rApp can utilize linear programming with a Matrix input X that can perform a set of iterations to use in combinatorial optimizations on the input versus the targeted KPIs to reattach the UE with the best available (or suitable) cell to meet the SLAs.

In some examples, operation 908 comprises performing at least one iteration of the obtaining of the fault-detection model to obtain at least one updated fault-detection model. That is, a fault optimization rApp can continue modifying the approach to improve its overall performance and changing the criteria of cells between red flags, green status, and yellow based on the over spectrum efficiency and average_user_thpt per cell, which can reflect a main category of user performance.

After operation 908, process flow 900 moves to operation 910.

Operation 910 depicts initiating a restart operation of a cell of the group of cells based on an output of the fault-detection model. That is, a restart rApp can use information from the FO rApp to initiate a cell restart operation.

In some examples, the output of the fault-detection model indicates that a number of service level agreement failures for user equipment that are attached to the cell is projected to exceed a failure threshold specified by a failure criterion within a defined amount of time. In some examples, a value of the failure threshold is determined from value data received from a user account that is associated with an operator of the group of cells. That is, in some examples, a cell restart operation can be initiated where a number of users within a cell exceeds a threshold value within X minutes. This threshold value can be defined by a mobile network operator (MNO) to meet an SLA for users.

After operation 910, process flow 900 moves to 912, where process flow 900 ends.

FIG. 10 illustrates an example process flow 1000 for fault optimization, and that can facilitate network self-healing and fault optimization, in accordance with an embodiment of this disclosure. In some examples, one or more embodiments of process flow 1000 can be implemented by system architecture 100 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 500 of FIG. 5, process flow 600 of FIG. 6, process flow 900 of FIG. 9, and/or process flow 1100 of FIG. 11.

Process flow 1000 begins with 1002, and moves to operation 1004.

Operation 1004 depicts, based on determining that at least one key performance indicator indicates that a group of cells is unable to facilitate broadband cellular communications, rerouting a user equipment among the group of cells, and generating a fault-detection model based on a result of applying linear programming to the determining. In some examples, operation 1004 can be implemented in a similar manner as operations 904-908 of FIG. 9.

In some examples, the cell is a first cell, the user equipment is a first user equipment, and the determining that the at least one key performance indicator indicates that the group of cells is unable to facilitate the broadband cellular communications comprises identifying a second cell of the group of cells for which the at least one key performance indicator indicates that the group of cells is unable to facilitate the broadband cellular communications, wherein the second cell comprises the first cell or another cell; and identifying a second user equipment for which the at least one key performance indicator indicates that the second user equipment is unable to facilitate the broadband cellular communications, wherein the second user equipment is attached to the first cell, and wherein the second user equipment comprises the first user equipment or another user equipment other than the first user equipment. That is, where it is determined that the KPIs were not met (e.g., at 508 of FIG. 5), values can be passed to a fault optimizer xApp.

In some examples, the determining that the at least one key performance indicator indicates that the group of cells is unable to facilitate the broadband cellular communications is performed based on data, wherein the data comprises at least one of a radio resource control maximum number of users connected per cell, a radio resource control average number of users connected per cell, a download physical resource block utilization, an upload physical resource block utilization, an average tolerated block error rate, an average download throughput per user equipment, or an average upload throughput per user. In some examples, the data is obtained from a database

After operation 1004, process flow 1000 moves to operation 1006.

Operation 1006 depicts initiating a restart operation of a cell of the group of cells based on an output from the fault-detection model. In some examples, operation 1006 can be implemented in a similar manner as operation 910 of FIG. 9.

In some examples, the determining is performed by an xApp (e.g., a FD xApp). In some examples, the rerouting is performed by an xApp (e.g., a TD xApp). In some examples, the generating is performed by an rApp (e.g., a FO rApp). In some examples, the restart operation is performed by an rApp (e.g., a restart rApp).

After operation 1006, process flow 1000 moves to 1008, where process flow 1000 ends.

FIG. 11 illustrates an example process flow 1100 for fault optimization, and that can facilitate network self-healing and fault optimization, in accordance with an embodiment of this disclosure. In some examples, one or more embodiments of process flow 1100 can be implemented by system architecture 110 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of process flow 500 of FIG. 5, process flow 600 of FIG. 6, process flow 900 of FIG. 9, and/or process flow 1000 of FIG. 10.

Process flow 1100 begins with 1102, and moves to operation 1104.

Operation 1104 depicts, based on determining that a key performance indicator is not threshold sufficient for broadband cellular communications facilitated by cells, rerouting a user equipment among the cells. In some examples, operation 1104 can be implemented in a similar manner as operations 904-908 of FIG. 9.

In some examples, the determining is performed by a first xApp, and wherein a second xApp further facilitates performance of the operations, comprising obtaining logs of cells from a database, and communicating information about the logs to the first xApp. This second xApp can be a KPIMON xApp.

In some examples, the determining is performed by a first xApp, and wherein the rerouting is performed by a second xApp based on information received from the first xApp. These xApps can be a FD xApp and a TR xApp, respectively.

In some examples, the generating is performed by a first rApp, and wherein the restarting is performed by a second rApp. These xApps can be a FO rApp and a restart rApp, respectively.

After operation 1104, process flow 1100 moves to operation 1106.

in some examples, the determining is performed by an xApp, wherein the generating is performed by an rApp, and wherein the xApp communicates with the rApp via an AI interface. This can be a FD xApp and a FO rApp, respectively.

Operation 1106 depicts restarting a cell of the cells based on an output of a fault-detection model that was generated based on a linear programming process applied to the determining. In some examples, operation 1106 can be implemented in a similar manner as operation 910 of FIG. 9.

After operation 1106, process flow 1100 moves to 1108, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of base station 102, UEs 104, and/or cells 110 of FIG. 1.

In some examples, computing environment 1200 can implement one or more embodiments of the process flows of FIGS. 5-6 and/or 9-11 to facilitate network self-healing and fault optimization.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1216 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
identifying that at least one key performance indicator is not satisfied for broadband cellular communications facilitated by a group of cells;
rerouting a user equipment among the group of cells based on the identifying;
obtaining a fault-detection model based on a linear programming process applied to the identifying; and
initiating a restart operation of a cell of the group of cells based on an output of the fault-detection model.

2. The system of claim 1, wherein the output of the fault-detection model indicates that a number of service level agreement failures for user equipment that are attached to the cell is projected to exceed a failure threshold specified by a failure criterion within a defined amount of time.

3. The system of claim 2, wherein a value of the failure threshold is determined from value data received from a user account that is associated with an operator of the group of cells.

4. The system of claim 1, wherein the obtaining of the fault-detection model is based on applying the linear programming process to a matrix, wherein respective rows of the matrix represent respective cells of the group of cells, and wherein respective columns of the matrix represent respective vector parameters of respective user equipment that have communicated with the respective cells.

5. The system of claim 4, wherein respective elements of the matrix identify the respective user equipment that are attached to the respective cells.

6. The system of claim 1, wherein the linear programming process comprises performing iterations of forming combinatorial optimizations.

7. The system of claim 1, wherein the operations further comprise:
performing at least one iteration of the obtaining of the fault-detection model to obtain at least one updated fault-detection model.

8. A method, comprising:
based on determining that at least one key performance indicator indicates that a group of cells is unable to facilitate broadband cellular communications,
rerouting, by a system comprising at least one processor, a user equipment among the group of cells, and
generating, by the system, a fault-detection model based on a result of applying linear programming to the determining; and
initiating, by the system, a restart operation of a cell of the group of cells based on an output from the fault-detection model.

9. The method of claim 8, wherein the cell is a first cell, wherein the user equipment is a first user equipment, and wherein the determining that the at least one key performance indicator indicates that the group of cells is unable to facilitate the broadband cellular communications comprises:
identifying a second cell of the group of cells for which the at least one key performance indicator indicates that the group of cells is unable to facilitate the broadband cellular communications, wherein the second cell comprises the first cell or another cell; and
identifying a second user equipment for which the at least one key performance indicator indicates that the second user equipment is unable to facilitate the broadband cellular communications, wherein the second user equipment is attached to the first cell, and wherein the second user equipment comprises the first user equipment or another user equipment other than the first user equipment.

10. The method of claim 8, wherein the determining that the at least one key performance indicator indicates that the group of cells is unable to facilitate the broadband cellular communications is performed based on data, wherein the data comprises at least one of a radio resource control maximum number of users connected per cell, a radio resource control average number of users connected per cell, a download physical resource block utilization, an upload physical resource block utilization, an average tolerated block error rate, an average download throughput per user equipment, or an average upload throughput per user.

11. The method of claim 10, wherein the data is obtained from a database.

12. The system of claim 1, wherein the determining is performed by an xApp.

13. The system of claim 1, wherein the rerouting is performed by an xApp.

14. The system of claim 1, wherein the generating is performed by an rApp.

15. The system of claim 1, wherein the restart operation is performed by an rApp.

16. A non-transitory computer-readable medium comprising instructions that, in response to execution, cause a system comprising at least one processor to perform operations, comprising:
based on determining that a key performance indicator is not threshold sufficient for broadband cellular communications facilitated by cells, rerouting a user equipment among the cells; and
restarting a cell of the cells based on an output of a fault-detection model that was generated based on a linear programming process applied to the determining.

17. The non-transitory computer-readable medium of claim 16, wherein the determining is performed by a first xApp, and wherein a second xApp further facilitates performance of the operations, comprising:
obtaining logs of cells from a database; and
communicating information about the logs to the first xApp.

18. The non-transitory computer-readable medium of claim 16, wherein the determining is performed by a first xApp, and wherein the rerouting is performed by a second xApp based on information received from the first xApp.

19. The non-transitory computer-readable medium of claim 16, wherein the generating is performed by a first rApp, and wherein the restarting is performed by a second rApp.

20. The non-transitory computer-readable medium of claim 16, wherein the determining is performed by an xApp, wherein the generating is performed by an rApp, and wherein the xApp communicates with the rApp via an AI interface.
